(19) United States
(12) Patent Application Publication
(10) Pub. No.: US 2006/0193310 A1
(43) Pub. Date: Aug. 31, 2006

(54) Local area network above telephony methods and devices

(75) Inventors: James F. Landry, Germantown, MD (US); Andrew Pozsgay, Germantown, MD (US)

Correspondence Address: VOLENTINE FRANCOS & WHITT, PLLC, SUITE 1260, 11951 FREEDOM DRIVE, RESTON, VA, 20190, US

(73) Assignee: Telkonet, Inc.

(21) Appl. No.: 11/064,850

(22) Filed: Feb. 25, 2005

(51) Int. Cl. H04L 12/66

(52) U.S. Cl. 370/356

(57) ABSTRACT

A method and apparatus for modifying a telephone network to create a local area network over telephony (LAN/T) communication system network is disclosed. By employing special coupler/filter arrangements that allow broadband communication signals to pass but preclude telephony signals from passing, a network of multiple telephony lines carrying separate telephony signals can be integrated into a single broadband network without interfering with ongoing telephony traffic.

### FIELD OF THE INVENTION

The methods and systems of this disclosure relate to adapting telephone infrastructures to carry both telephonic and non-telephonic communication signals.

### BACKGROUND OF THE INVENTION

The ability to interconnect computers and other intelligent devices is a common requirement wherever people live and work today. The electrical connections required to form many local area network (LAN) communication systems have traditionally been accomplished by installing dedicated wiring both inside buildings and between clusters of buildings. A number of wireless (i.e. radio) methods have also been developed and deployed to address this need.

More recently, a power-wire based technology was developed to allow electric power wiring infrastructure to simultaneously transport electrical power and high-speed data. This technology, known as “Power Line Carrier” (PLC) technology, typically uses broadband Orthogonal Frequency Division Modulated (OFDM) signals between 2 MHz and 30 MHz to facilitate communication on power wiring.

Power Line Carrier technology offers a number of significant practical advantage over other available LAN-based technologies. For example, a PLC-based LAN can be installed in a house or other building without installing a single in-wall wire. Further, PLC-based LANS can cover a greater area than can available wireless LANS. Unfortunately, existing PLC-based LANs have a limited data bandwidth of about 14 million bits-per-second and are subject to interference by every appliance and device drawing power from a LAN's power lines. Accordingly, new methods and systems capable of providing in-building LANs are desirable.

### SUMMARY OF THE INVENTION

In one aspect, a device for implementing a broadband communication network using a wired telephone network installed in a building includes a plurality of high-pass filters, wherein each high-pass filter is configured to electrically couple two telephone wire-pairs, and wherein each high-pass-filter is configured to pass high-frequency broadband communication signals while isolating low-frequency telephony signals.

In a second aspect, an apparatus for adapting a wired telephone network to carry a high-frequency broadband communication system includes a broadband communication device coupled to a first wire-pair, wherein the broadband communication device is configured to communicate over the first wire-pair using high-frequency broadband signals having a lowest frequency component greater than any frequency component of telephony signals traversing the first wired pair, and at least one high-pass filter electrically connecting the first wire-pair to a second wired pair, wherein the high-pass filter is configured to allow high-frequency broadband signals to traverse between the first wire-pair and the second wire-pair while blocking telephony traffic from traversing between the first wire-pair and the second wire-pair.

In a third aspect, a method for adapting a wired telephone network to work as a Local Area Network (LAN) includes providing a high-pass filter between a first wire pair and a second wire pair, wherein the high-pass filter is configured to allow high-frequency broadband signals to traverse between the first wire-pair and the second wire-pair while blocking low-frequency telephony traffic from traversing between the first wire-pair and the second wire-pair, and broadcasting first high-frequency broadband signals onto the first wire-pair, wherein the high-frequency broadband signals are compliant with a LAN protocol.

In a fourth aspect, a communication network for simultaneously transmitting telephonic and non-telephonic communication signals includes one or more couplers configured to receive non-telephonic communication signals from at least one gateway and inject the non-telephonic communication signals onto a wired telephone network, wherein the wired telephone network includes a telephonic external access device, a plurality of telephones and a plurality of respective telephone wire-pairs that are effectively isolated from one another at telephonic frequencies such that each wire-pair can carry a respective telephonic signal between the telephonic external access device and a respective telephone, wherein the one or more couplers are configured to inject a common broadband signal onto all of the wire-pairs.

In a fifth aspect, a Local Area Network (LAN) includes a plurality of high-frequency communication devices, wherein each communication device is coupled to a respective wire-pair, and wherein each wire-pair is capable of carrying a separate low-frequency telephonic signal, and a coupling means for coupling the high-frequency communication devices while isolating telephonic signals.

In a sixth aspect, an apparatus for adapting a wired telephone network to carry a high-frequency broadband communication system includes a circuit board, the circuit board itself including: a substrate; a broadband coupler affixed to the substrate and adapted to couple high-frequency communication signals between a gateway and the circuit board; and a plurality of high-pass-filters affixed to the substrate, each high-pass-filter having a first port and a second port and being configured to pass signals above 2 Mhz and reject signals below 100 KHz, wherein the first port of each high-pass-filter is electrically coupled to a first connector and wherein at least one high-pass-filter has a second port electrically coupled to a port of the broadband coupler, and wherein each first connector is adapted to be connected to one of a plurality of twisted-wire-pairs of the wired telephone network, and wherein each twisted-wire-pair is capable of carrying a separate telephonic communication signal.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts the spectra used by many telephone and broadband WAN technologies.

FIG. 2 depicts the spectra used by a HomePlug LAN above Telephony (LAN/T) network.

FIG. 3 depicts the spectra used by a HomePlug LAN above ADSL WAN above telephony network.

FIG. 4 depicts the spectra used by a HomePlug LAN above VDSL WAN above telephony network.

FIG. 5 depicts an exemplary LAN imposed on a telephony network.

FIG. 6 is an exemplary coupler for the network of FIG. 5.

FIG. 7 is an exemplary an exemplary client access point for the network of FIG. 5.

FIG. 8 depicts a high-level communication architecture of a LAN above Telephony network.

FIG. 9 is a block diagram of an exemplary telephone external access device.

FIG. 10A depicts a first coupling architecture for a LAN above Telephony network.

FIG. 10B depicts a second coupling architecture for a LAN above Telephony network.

FIG. 10C depicts a third coupling architecture for a LAN above Telephony network.

FIG. 10D depicts a fourth coupling architecture for a LAN above Telephony network.

FIG. 10E depicts a fifth coupling architecture for a LAN above Telephony network.

FIG. 11 depicts a coupling architecture for a LAN above WAN above Telephony network.

FIG. 12A depicts a printed circuit board portion populated in a manner to support a LAN above Telephony network.

FIG. 12B depicts a printed circuit board portion populated in a manner to support a LAN above Telephony network.

FIG. 12C depicts a second printed circuit board portion populated in a manner to support a LAN above Telephony network.

FIG. 12D depicts a third printed circuit board portion populated in a manner to support a LAN above Telephony network.

FIG. 13 is a flowchart outlining a first exemplary method for communicating using a LAN above Telephony network.

FIG. 14 is a flowchart outlining a second exemplary method for communicating using a LAN above Telephony network.

FIG. 15A depicts details of a first coupler arrangement.

FIG. 15B depicts details of a second coupler arrangement.

FIG. 15C depicts details of a third coupler arrangement.

FIG. 16 illustrates another coupling architecture for a LAN/Telephony network

### DETAILED DESCRIPTION

Current technologies available to homeowners to create Local Area Networks (LANs) include various wireless technologies, such as Bluetooth and 802.11 networks, and Power Line Communication (PLC) networks, such as those provided by the HomePlug® standards. Unfortunately, both technologies have limited bandwidth, which can prove problematic in high-density housing and office settings.

However, most buildings that have electrical wiring also have telephone wires installed that might also be used to provide LAN services. While the standards-making bodies of the International Telecommunications Union (the “ITU-T”) have promulgated a number of broadband above telephony standards, such as Asymmetric Digital Subscribe's Line above Plain Old Telephone Service (ADSL above POTS), these standards were developed for point-to-point communication/Wide Area Network (WAN) systems where design emphasis has been sending and receiving data over long distances in an upstream/downstream configuration.

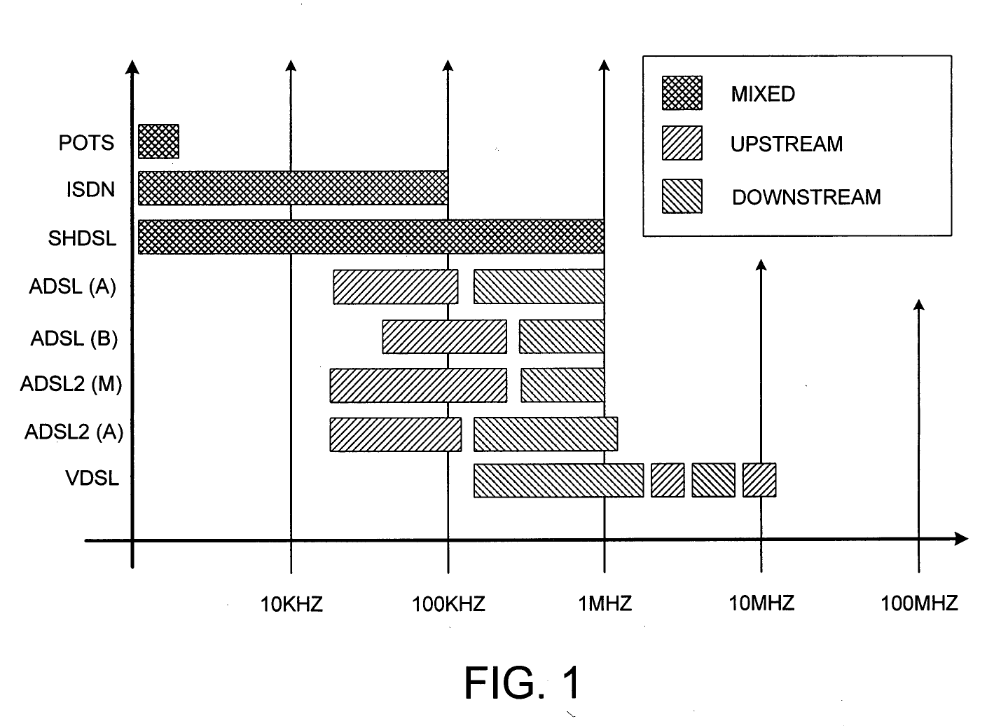

FIG. 1 depicts the bandwidths of various telephony standards, including POTS and Integrated Services Digital Network (ISDN), as well as a number of Digital Subscriber's Loop (DSL) technologies including Symmetric High-bitrate DSL (SHDSL), various Asymmetric DSL (ADSL) standards and a Very high-speed DSL (VDSL) standard. Given that the telephony standards use but a small bandwidth compared to the available bandwidth made available by twist-wire pairs, standards like ADSL above POTS and ADSL above ISDN have proven useful for their intended purposes, i.e., utilizing existing telephony twisted-wire-pairs for broadband WAN communications.

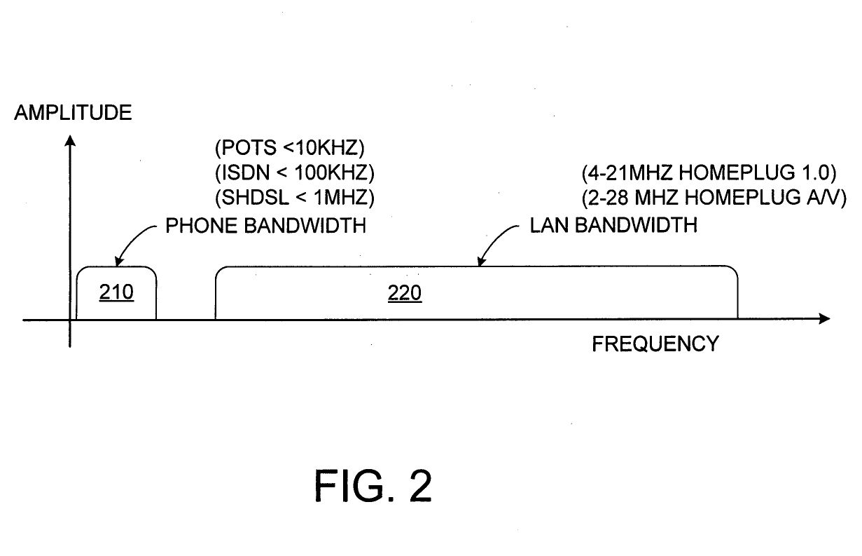

However, there is a broadband LAN technology known as HomePlug® that was developed for power line communications, that can potentially be used on telephony twisted-wire-pairs. Further, in addition to HomePlug, there are a potentially a large number of viable variants to HomePlug capable of providing LAN services both over powerlines and telephony twisted-wire-pairs. FIG. 2 depicts the spectral map of a broadband LAN above Telephony (LAN/T) network using either the HomePlug 1.0 standard or the HomePlug A/V standard. That is, as shown in FIG. 2, a LAN spectra 220 can co-exist with a baseband telephony spectra 210, such as POTS or ISDN (or alternatively SHDSL, which can simultaneously carry both telephony and other data).

While FIG. 2 was formed with the HomePlug standards in mind, it should be appreciated that any number of broadband LAN standards might be promulgated in order to provide LAN/T services. However, in order to be most effective, such standards might desirably include the following attributes:

(A) Point-to-multipoint capability, which refers to the capability where a first device can simultaneously communicate with multiple other devices on a LAN. Compare direct point-to-multipoint capability, which refers to the capability where a first device can simultaneously communicate with multiple other devices on a LAN without intervention of an intermediate device, such as a network hub. Also compare Specific-frequency point-to-multipoint capability, which refers to the capability where a first device can simultaneously communicate with multiple other devices on a LAN using a particular carrier frequency. Contrast this capability with the various DSL standards, which generally allow only point-to-point communication. While there are some DSL standards that are partially point-to-multipoint from the standpoint that an upstream device can simultaneously communicate with multiple downstream devices, such communication is limited in that the upstream device maintains communication with each downstream device using separate carrier frequencies in a Discrete Multi-Tone (DMT) environment.

(B) Digital encryption, such as the Digital Encryption Standard (DES) or triple Digital Encryption Standard (3DES or DES3). Presently, DSL and other known WAN standards do not use or need such capability.

(C) An Orthogonal Frequency Division Multiplexing (OFDM) format, which helps to increase data bandwidth while decreasing the effects of multi-path signal distortion. While various DSL protocols use a signal format having similarities to OFDM known as DMT, OFDM has a number of advantages over DMT, such as the need for but a single modem.

(D) A contention protocol, such as Carrier Sense Multiple Access/Collision Detection (CSMA/CD), Carrier Sense Multiple Access/Collision Avoidance (CSMA/CA) and Token Passing. The CSMA/CD is a popular protocol that is both fast and commonly used. Examples of networks using CSMA/CD include Ethernet and 100baseT networks.

While the CSMA/CA protocol is not as fast as the CSMA/CD protocol, CSMA/CA has an advantage in that it provides for the “hidden node” problem. The hidden node problem occurs in a point-to-multipoint network having at least three nodes, e.g., Node A, Node B and Node C. It may be possible that in certain cases Node B can hear Node A (and vice versa) and Node B can hear Node C (and vice versa) but Node C cannot hear Node A. That is, Nodes A and C are effectively hidden from one another. In such an environment both Node A and Node C could both properly transmit a packet simultaneously in a CSMA/CD environment since they cannot hear each other on a ‘listen’ phase, but the result is that Node B would get corrupted data. However, unlike a CSMA/CD protocol, a CSMA/CA protocol could prevent Nodes A and C from simultaneously transmitting (with resulting data corruption).

(E) Full spectral bi-directionality, which for the purpose of this disclosure means that almost any device coupled to a network can both receive and transmit information using all or substantially all of an available communication bandwidth. For example, the POTS, ISDN and SHDSL technologies shown in FIG. 1 have full spectral bi-directionality in that their entire useable bandwidths can be used for both transmission and reception. In contrast, the ADSL and VDSL standards allocate separate spectra for separate upstream and downstream data transmission.

(F) Error Detection and/or Error Correction, which . . . Cyclic Redundancy Coding *CRC), Forward Error Correction (FEC), Block coding, such as BCH

(G) Packet Transmission, which refers to a form of communication where information is divided into discrete packages (“packets”) of a predetermined size, formatted according to a particular protocol, transmitted packet-by-packet to a desired destination, then reassembled to resemble the original information.

(G) Burst Transmission, generally refers to a form of data transmission that combines a high data signaling rate with short transmission times or the operation of a data network in which data transmission is interrupted at intervals

(H) Bus Topology generally refers to networks that use a common physical connection for communication. That means the physical media is shared between devices. When devices attempt to access the network bus at the same time, some method must be used to prevent a collision, such as CSMA/CD. These types of network are most commonly seen with coaxial cable as their physical medum. Token Bus, Ethernet are common examples of bus topologies.

(I) Hub-and-Spoke Topology generally refers to a network topology where there is a central connection point to which multiple devices are connected. It can be noted that a “hub device” is not the only device usable in this configuration in that a bridge or switch may also be used. Ethernet utilizing twisted pair is STILL considered a BUS architecture from a logical standpoint, however, physically, an Ethernet network can be wired as a hub and spoke model. Generally, each device at a spoke of this topology must communicate with one another by relaying messages with the hub device.

(J) Non Hub-and-Spoke Topology can refers to any non-hub and spoke topology, such as a Token Ring network.

(K) Hub-Versatile Topology, can refer to a topology that can operate as a hub and spoke network in some instances and operate in alternative modes in other instances.

(L) Daisy-chain Topology, which is a form of non hub-and-spoke topology

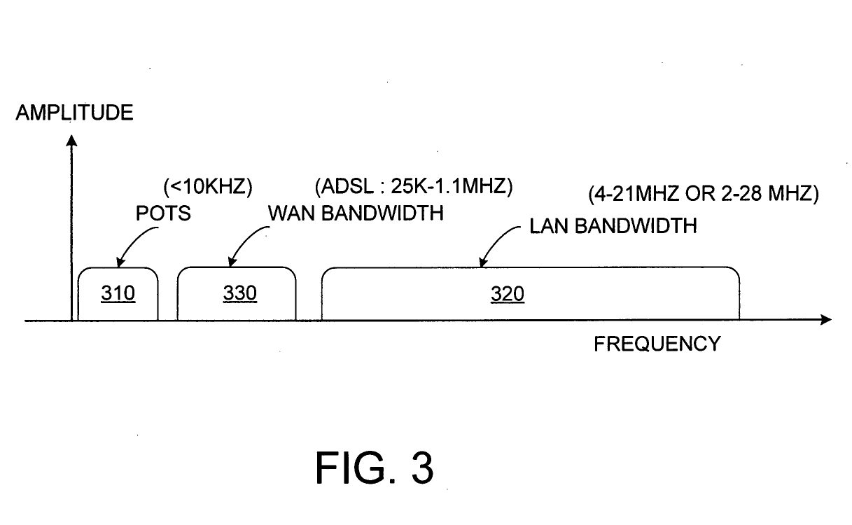

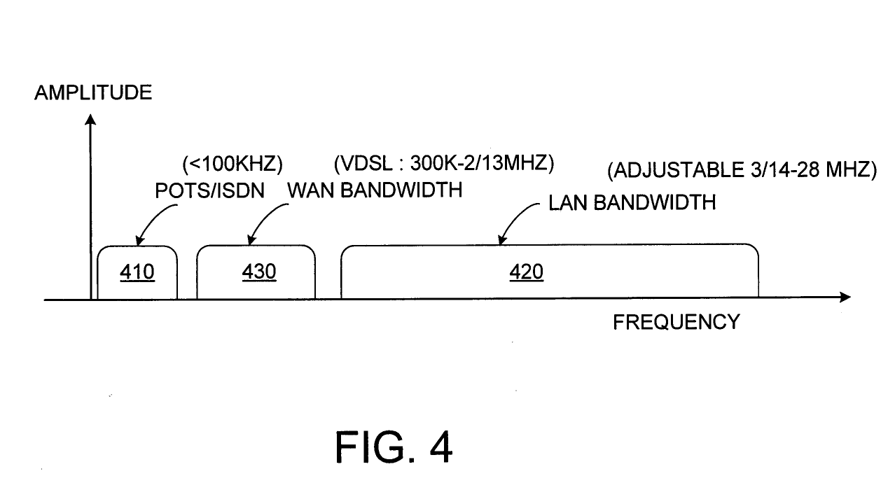

Continuing to FIG. 3, a spectral map of a LAN above WAN above Telephony (LAN/WAN/T) communication system is shown indicating the viability that a twisted-wire-pair can carry a POTS telephony signal 310, an ADSL WAN signal 330 and a HomePlug LAN signal 320. Continuing to FIG. 4, a second LAN/WAN/T spectral map is shown having a POTS (or ISDN) telephony signal 410, a VDSL WAN signal 430 and a HomePlug LAN signal 420. As the VDSL standard uses varied amounts of bandwidth, and known HomePlug modems can be programmed to use or ignore specific frequencies, it should be appreciated that it is possible to allocate LAN and WAN bandwidth based on the needs of a specific communication system without LAN-WAN interference.

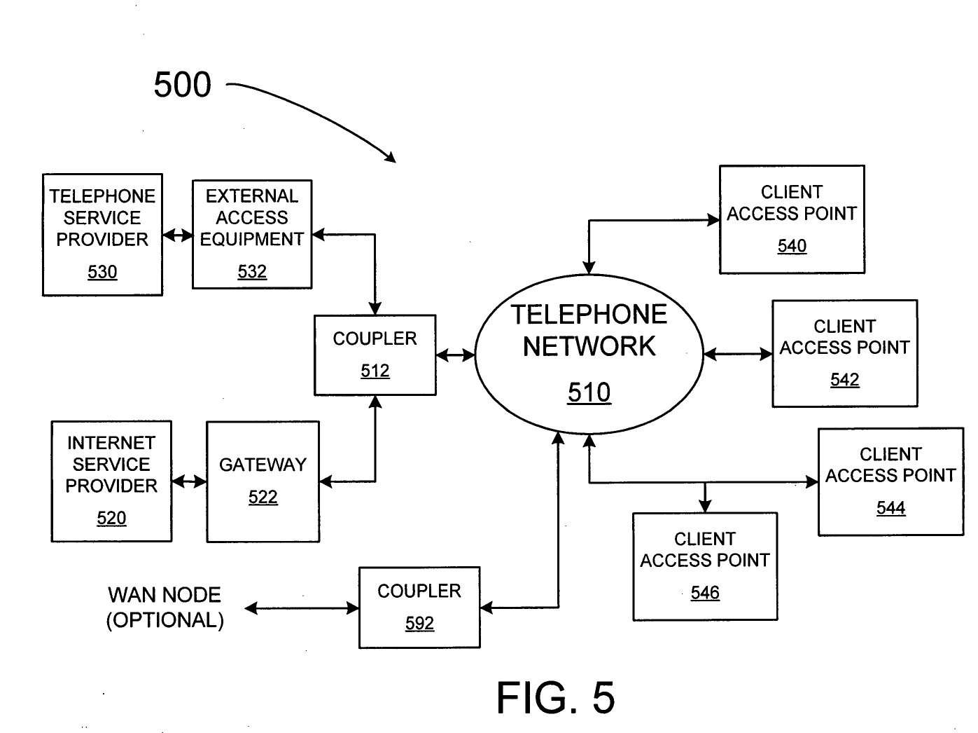

FIG. 5 depicts an exemplary communication system 500 wherein a LAN is imposed on a telephony network. As shown in FIG. 5, the communication system 500 includes a telephone network 510 coupled to a telephone service provider 530 via some external access equipment 532 and a coupler 512. The telephone network 510 is also coupled to, an internet service provider (ISP) 520 via a LAN gateway 522 and LAN/T coupler 512. Still further, the telephone network 510 is coupled to a number of client access points 540-546 and an optional external WAN node (not pictured) via a WAN coupler 592.

In operation, the telephone network 510 can be used to transport telephony signals (or other baseband signals, such as SHDSL) between various telephones, facsimile machines, modems or telephony equipment located at the client access points 540-546 and the telephone service provider 530, or possibly used to transport telephony signals between one client access point and another. When a client access point 540-546 is in communication with the telephone service provider 530, the telephony signals would, of course, be relayed/transmitted/received via the external access equipment 532 and coupler 512

Simultaneously, the telephone network 510 can be used to transport various broadband signals, such as HomePlug compatible (or other LAN signals) both between client access points 540-546 and to/from individual client access points 540-546 and an external device or system, e.g., a specific communication node on the ISP 520. When a client access point 540-546 is in communication with the ISP 520, the broadband signals would, of course, be relayed/transmitted/received via the LAN gateway 522 and coupler 512.

As discussed above with reference to FIGS. 3 and 4, in addition to the telephony and LAN signals, the telephone network 510 might also be used to convey WAN signals to and from an external WAN node via the WAN coupler 592.

The exemplary telephone network 510 consists of one or more pairs of twisted-wire-pairs commonly used for telephony purposes. However, it should be appreciated that the particular physical makeup of the telephone network 510 can take any combination of forms, such as electrically conducting wire-pairs, twisted-wire-pairs, coaxial cable etc. It should also be appreciated that, when the telephone network 510 takes such electrically conducting forms, the telephone network 510 may consist of one or more pairs of TIP and RING nodes capable of carrying a common telephony signal in certain embodiments, or capable of carrying numerous separate telephony signals in other embodiments. For example, a TIP/RING pair in a POTS environment can carry a single analog telephony signal while a TIP/RING pair in an ISDN environment can carry multiple digital telephony signals.

The external access equipment 532 of the present example of FIG. 5 is a POTS-based interface. However, the external access equipment 532 can also take the form of a Private Branch eXchange (PBX) system, a Private Automated Branch eXchange (PABX) system or any other known or later developed form of telephony equipment capable of linking telephony equipment with a telephony service provider (or possibly interlinking different pieces of telephony equipment) without departing from the spirit and scope of the present disclosure.

The gateway 522 of the present example of FIG. 5 can any of a number of HomePlug-based gateways capable of interconnecting computer-based devices on a telephone network and possibly interconnecting these devices with an ISP or other external data node. However, in variants not using HomePlug technology, the gateway 522 is envisioned to take any suitable form capable of communicating with various computer-based devices over a telephone network using a LAN protocol without departing from the spirit and scope of the present disclosure.

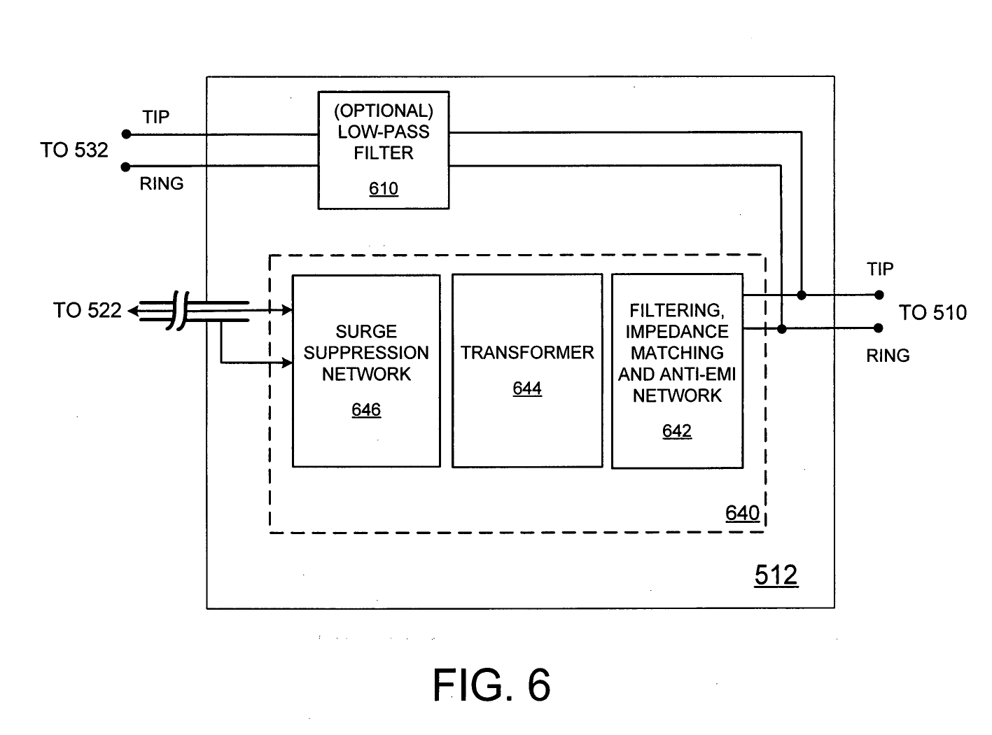

FIG. 6 depicts an exemplary coupler 512 capable of linking both a baseband telephony device and a broadband communication device to a common network, such as the telephony network 510 depicted in FIG. 5. As shown in FIG. 6, the coupler 512 includes a low-pass-filter 610 and a broadband data coupler 640. The data coupler 640 includes a filtering, impedance matching and anti-EMI (electromagnetic interference) network 542, a transformer 544 and a surge suppression network 546. The filtering and impedance matching network 542 is used to appropriately match the characteristics of a gateway to a telephony network; the transformer 544 is used to provide for electrical isolation and to eliminate low-frequency signals from reaching a gateway; and the surge suppression network 546 is used to prevent high-voltage spikes that may appear on a particular telephony network from damaging a gateway (or other equipment), prevent human injury and to generally to conform to any applicable regulations or mandates of telephony networks.

In operation, the low-pass-filter 610 (which may be optional in certain situations depending on the LAN signal power levels and sensitivities of the particular telephony equipment used), can be used to block out high-frequency signals, but to otherwise leave the telephony signals typically found on Tip-Ring pairs (such as voice and POTS signaling) unaltered. Thus, the TIP-RING pairs depicted on both the right-hand and left-hand sides of FIG. 6 should essentially appear as the same POTS or ISDN (or possibly SHDSL) nodes for low frequencies.

The data coupler 640, which complements the low-pass-filter 610, can essentially provide many complementary functions for higher-frequency signals, e.g., filtering out undesirable low-frequency signals while coupling desirable high-frequency signals. However, as mentioned above the data coupler 640 may also be required to provide surge protection, provide impedance matching to improve system reliability and performance and further provide some EMI filtering to remove unwanted high-frequency noise from leaking from a gateway onto the TIP and RING lines.

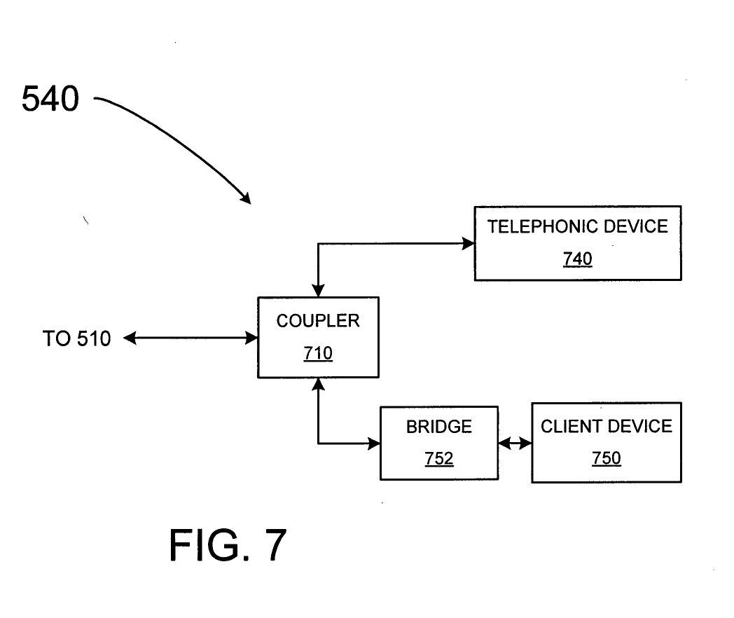

FIG. 7 depicts an exemplary client access point 540 according to the present disclosure. As shown in FIG. 7, the exemplary client access point 540 includes a client coupler 710, a telephonic device 740, a client bridge and a client device 750.

In operation, the telephonic device 740, which can be any combination of telephone-based devices such as telephones, facsimiles, modems etc, can transmit signals to (and receive signals from) a wired network, such as the telephone network 510 shown in FIG. 5, via the client coupler 710.

Similarly, the client device 750, which can be almost any computer-based device capable of transmitting and receiving data, can transmit signals to (and receive signals from) the same wired telephone network via the client bridge 752 and client coupler 714.

The client coupler 710 of the present embodiment can be similar to the coupler of FIG. 6 and can have both a low-pass-filtering portion to isolate high-frequency signals residing on a network from the telephonic device 740, and a data coupling portion to effectively couple high-frequency data signals between a network and the client bridge 752. However, it is envisioned that the exact makeup and architecture of the client coupler 710 may change based on the particular nature of the telephony and broadband signals, or possible change to accommodate client access points that only require telephony services or only require data services. For example, if a particular client access point includes but a simple POTS telephone, a high-frequency data coupler would not be necessary. Similarly, a client access point having no telephone would require no low-pass filtering device.

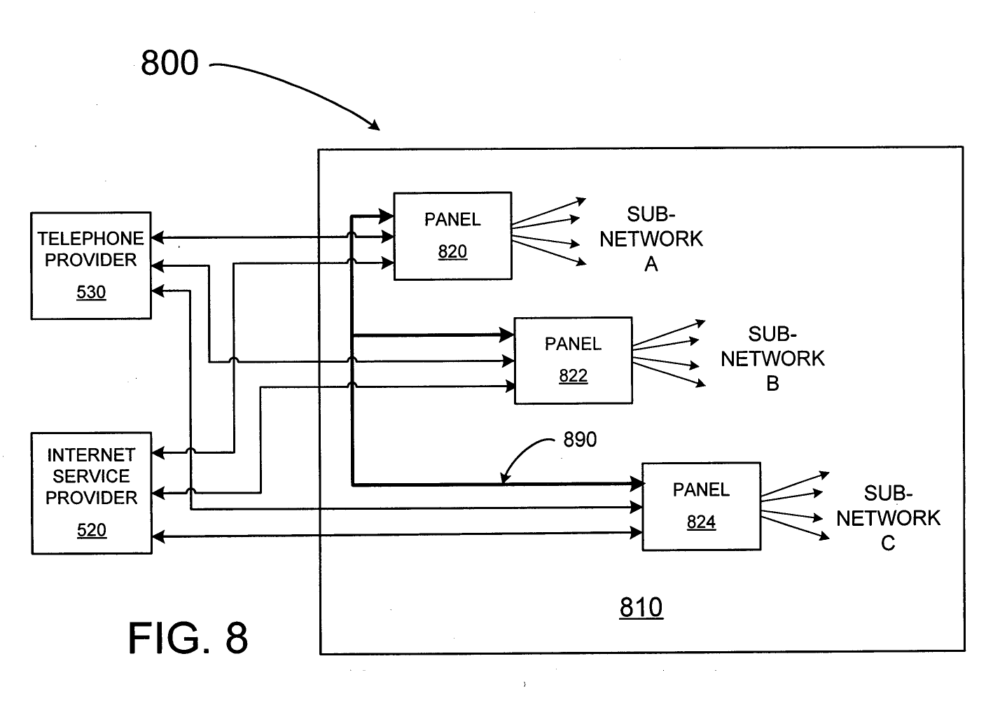

FIG. 8 depicts a high-level communication architecture of a LAN/Telephony network located in a single building 810 having a number of independent and electrically isolated telephony sub-networks A, B and C, which can be accessible by respective panels (equipment centers) 820, 822 and 824 also located within the building 910. The exemplary panels 820, 822 and 824 of the exemplary embodiment can be accessed by a common telephone provider 530 and common ISP 520, but in other embodiments panels 820, 822 and 824 can be accessed by different telephony and ISPs. It should be appreciated that electrical isolation of the sub-networks A, B and C can provide a boon as individual gateways (potentially located at each panel 820, 822 and 824) can have a lower number of clients to serve, thus increasing the available bandwidth per client.

However, in certain circumstances where a substantial connectivity between two sub-networks is required, the isolation depicted in FIG. 8 can pose a disadvantage when a client on one sub-network needs to quickly communicate with another client on another sub-network. Accordingly, a common network line 890 can be installed between the panels 820, 822 and 824 to alleviate such isolation. The common network line 890 of the exemplary embodiment is an Ethernet-based line using dedicated wiring and is connected to gateways (not shown but residing in the panels 820, 822 and 824) capable of converting signals between LAN/T and ethernet formats. However, it should be appreciated that in various embodiments the form of the common network line 890 can vary to employ any number of known technologies and forms, such as a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

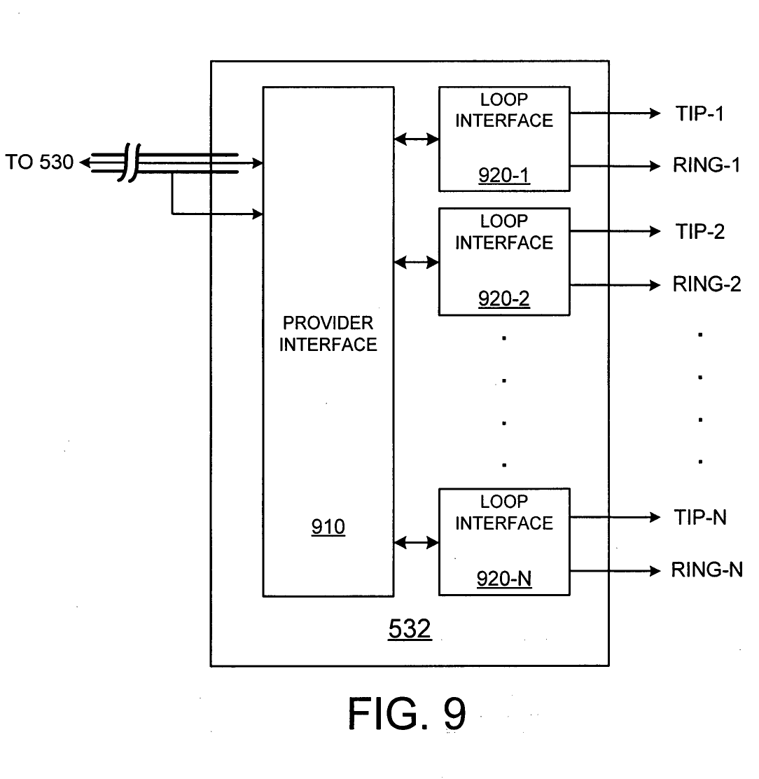

FIG. 9 is a block diagram of an exemplary telephone external access device 532. As shown in FIG. 9, the telephone external access device 532 includes a provider interface 910 coupled to a number of subscriber loop interfaces 920-1 . . . 920-N. The exemplary telephone external access device 532 is a POTS-based device capable of communicating with an external high-speed telephony node via a T1 or E1 communication link, and further capable of communicating with a large number of telephonic devices via subscriber's line interfaces embodied by the various TIP/RING line pairs provided by the subscriber loop interfaces 920-1 . . . 920-N.

While the exemplary telephone external access device 532 of FIG. 9 is a POTS device, as mentioned above the telephone external access device 532 can take the form of any know or later developed telephony interface of similar function, such as a PBX system, a PABX system and so on. It should also be appreciated that the form of communication between the telephone external access device 532 and the external world can also vary from T1/E1 lines to any other known or later developed form of communication, including those communication links mentioned above.

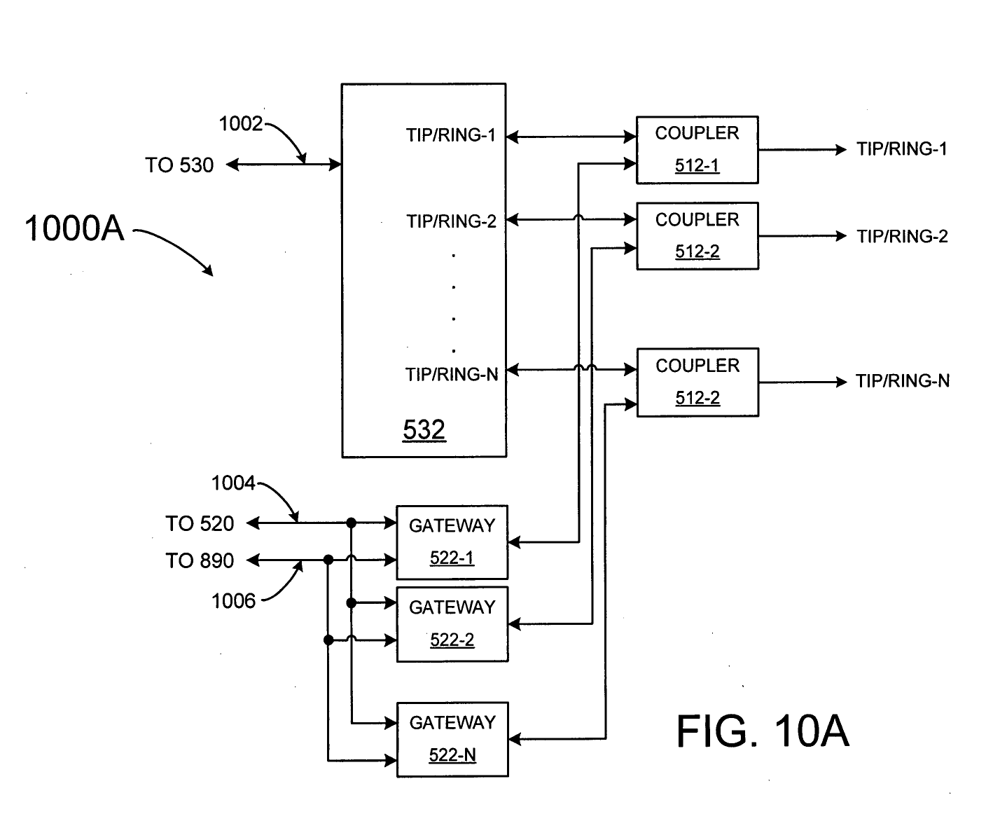

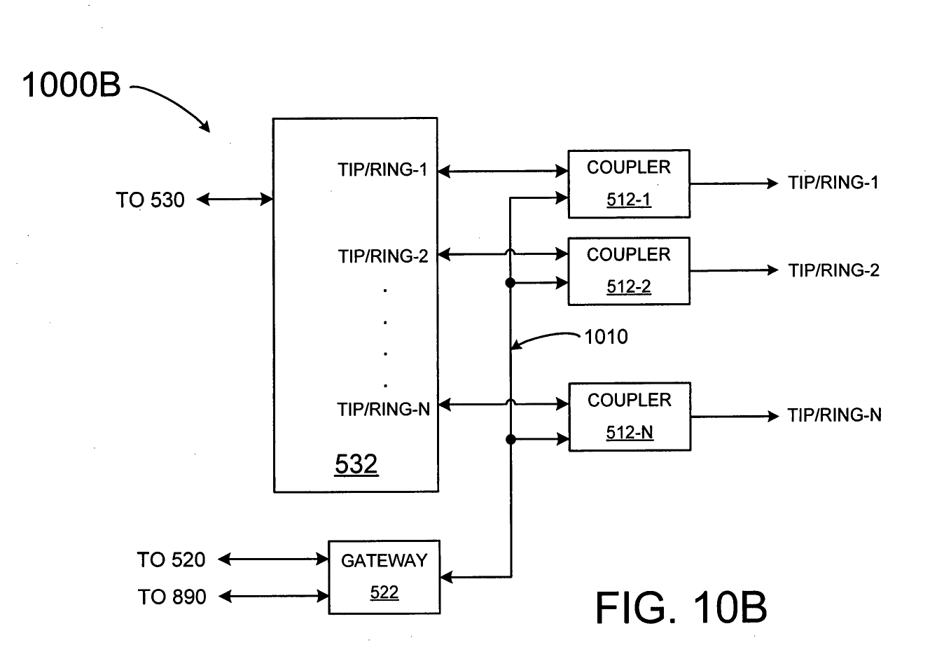

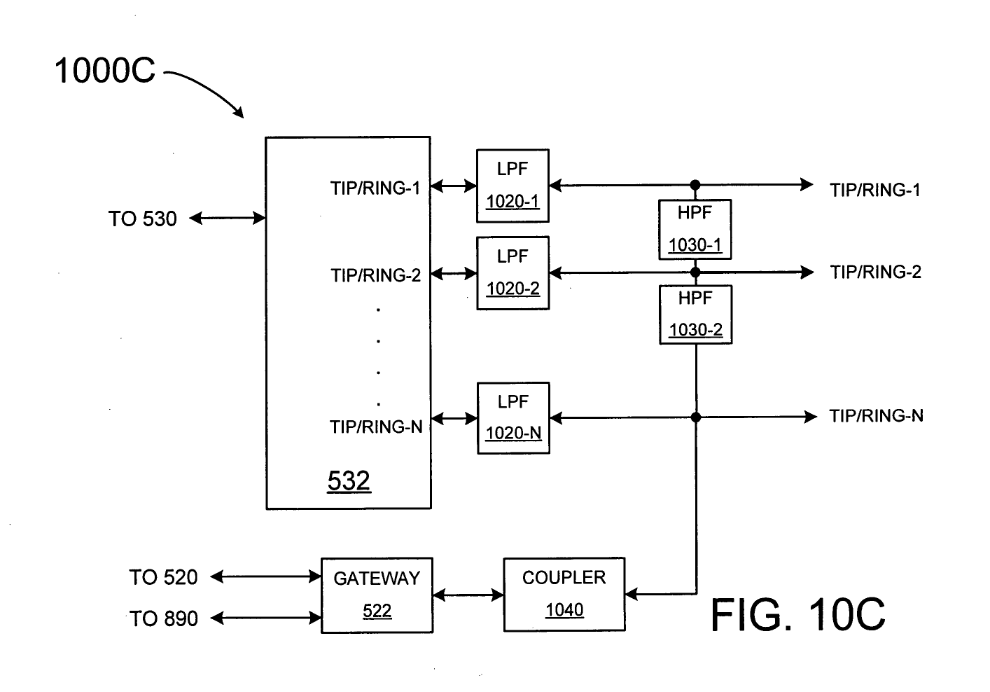

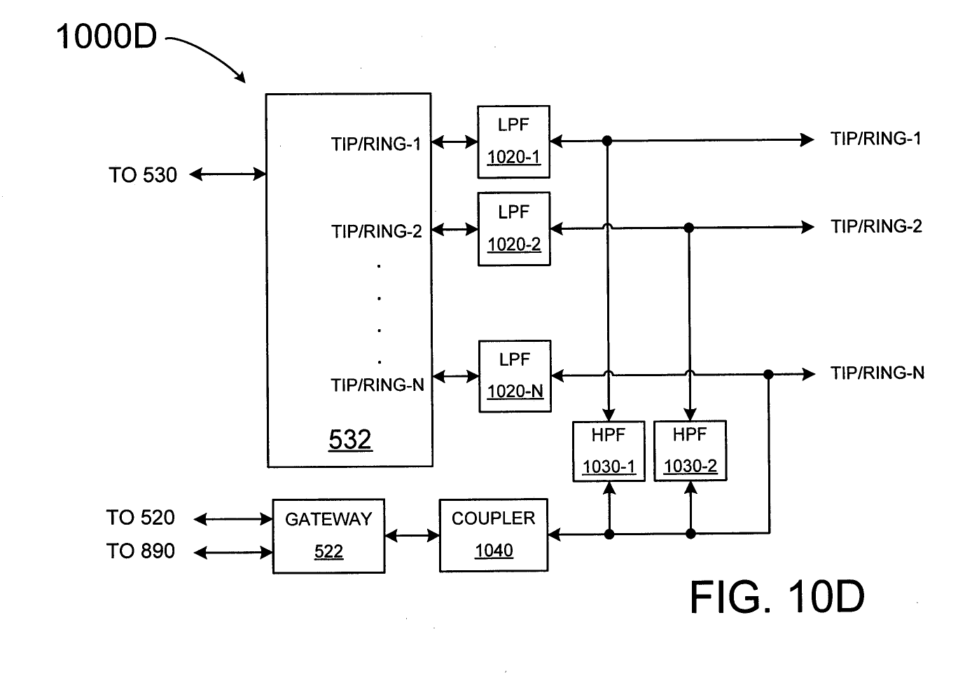

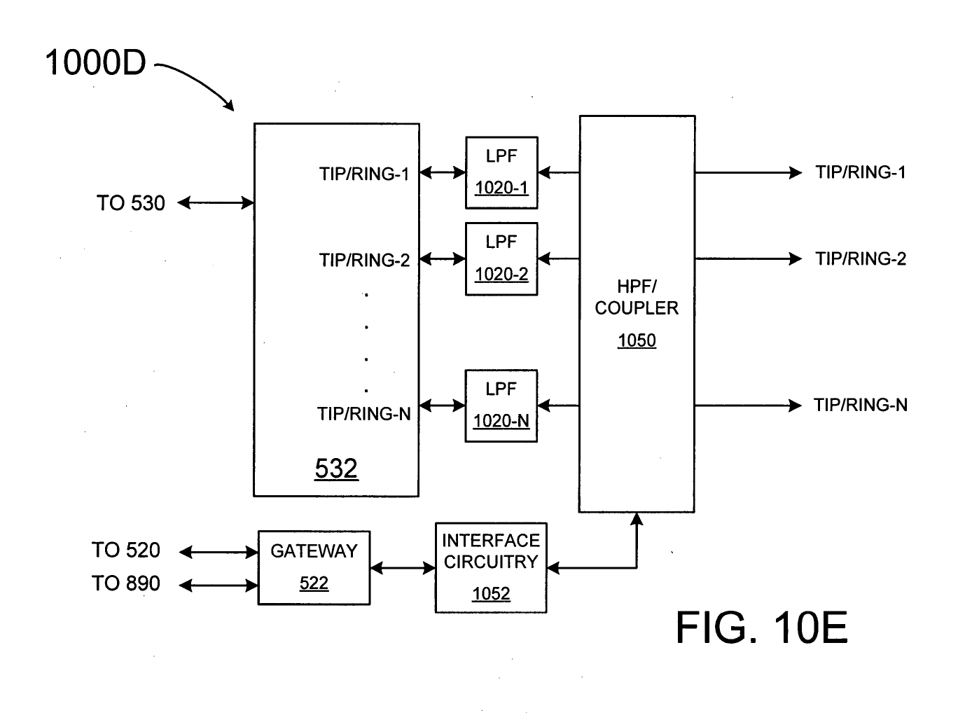

FIG. 10A depicts a first coupling architecture 1000A for a LAN/T network using a telephone external access device 532 having a number of TIP/RING (subscriber's line interface) lines pairs TIP/RING-1 . . . TIP/RING-N, a number of respective LAN/T couplers 512-1 . . . 512-N and a number of respective LAN/T gateways 522-1 . . . 522-N. As shown in FIG. 10A, the telephone external access device 532 can access a telephony provider via a first link 1002, and the LAN/T gateways can access both an ISP provider and other LAN/T gateways using two separate links 1004 and 1006.

Given that there is a gateway per TIP/RING pair, it could be expected that the architecture 1000A could provide excellent internet access. Further, as the gateways 522-1 . . . 522-N share a common link (1004 or 1006), client-to-client communication can also be easily provided. For example, a first client coupled to TIP/RING-1 could broadcast a LAN message to gateway 522-1 via coupler 512-1. Gateway 522-1 could receive the message and pass the message to gateway 522-2 via link 1006, and gateway 522-2 could then pass the message to an intended recipient on TIP/RING-2 via coupler 512-2.

FIG. 10B depicts a second coupling architecture 1000B for a LAN above Telephony network similar to that shown in FIG. 10A but using only a single gateway 522. As the second coupling architecture 1000B is likely to have a larger client-to-gateway ratio than the first coupling architecture 1000A, internet access for each client may not be as robust. However, the second coupling architecture 1000B not only has a cost advantage as compared to the first coupling architecture 1000A, but client-to-client communication can improve. For example, For example, a first client coupled to TIP/RING-1 could broadcast a LAN message to gateway 522 via coupler 512-1. Gateway 522-1 could receive the message and rebroadcast the message to a second client on TIP/RING-2 via coupler 512-2 without the intervention of a second gateway. Alternatively, the first client might transmit a message directly to the second client via couplers 512-1 and 512-2 as they share a common communication node 1010.

FIG. 10C depicts a third coupling architecture 1000C for a LAN/Telephony network. As shown on FIG. 10C, the various couplers 512-1 . . . 512-N are replaced by a single coupler 1040 and a series of low-pass filters (LPFs) 1020-1 . . . 1020-N and high-pass filters (HPFs) 1030-1 . . . 1030-N. This architecture 1000C can provide an even further advantage in that the cost of the filters 1020-1 . . . 1020-N and 1030-1 . . . 1030-N can be made less that the cost of couplers. About the same internet access and client-to-client access can be expected as compared to second coupling architecture 1000B.

In operation, the LPFs 1020-1 . . . 1020-N can be expected to protect the external access device 532, but may not be necessary when the power levels of ongoing LAN traffic are appreciably low, thus providing further savings. Client-to-gateway and client-to-client communication is provided for by the various HPFs. For example, a first client coupled to TIP/RING-1 could broadcast a LAN message to a second client on TIP/RING-2 via HPF 1020-1. Similarly, the first client of the example above can communicate with the gateway 522 via HPF 1030-1, HPF 1030-2 . . . and coupler 1040. Generally, coupler 1040 is expected to resemble the broadband data coupler 640 of FIG. 6, but can obviously take a number of variant forms to adjust for impedance, surge suppression and EMI factors that may change from one particular circuit to another. For example, as a single coupler 1040 is linked to numerous TIP/RING pairs, the particular impedance-matching circuitry and EMI protection may need to be changed to compensate for the much increased amount of parallel wire-pairs that must be driven by a single gateway.

FIG. 10D depicts a fourth coupling architecture 1000D for a LAN/Telephony network similar to that of the third coupling architecture 1000C, but having an improved arrangement of HPFs 1030-1 . . . 1030-N. In particular, the fourth coupling architecture 1000D can be expected to have more dependable overall client-to-client communication as each client to client LAN broadcast need but pass though two HPFs maximum for direct client-to-client communication, or through one HPF (maximum) and one coupler if the gateway 522 is used as a repeater. Similarly, client-gateway communications need only pass through one HPF (maximum) and one coupler.

FIG. 10E depicts a fifth coupling architecture 1000E for a LAN/Telephony network similar to that of the coupling architecture 1000B, but having an improved arrangement where HPFs and couplers are combined into a single HPF/Coupler device 1050 with an optional interface circuit 1052 providing surge suppression and impedance matching functions. EMI considerations can be handled either in the interface circuitry 1052 or the HPF/Coupler 1050. The exemplary HPF/Coupler device 1050 is based on an inductive technology and include any of a number of inductive devices.

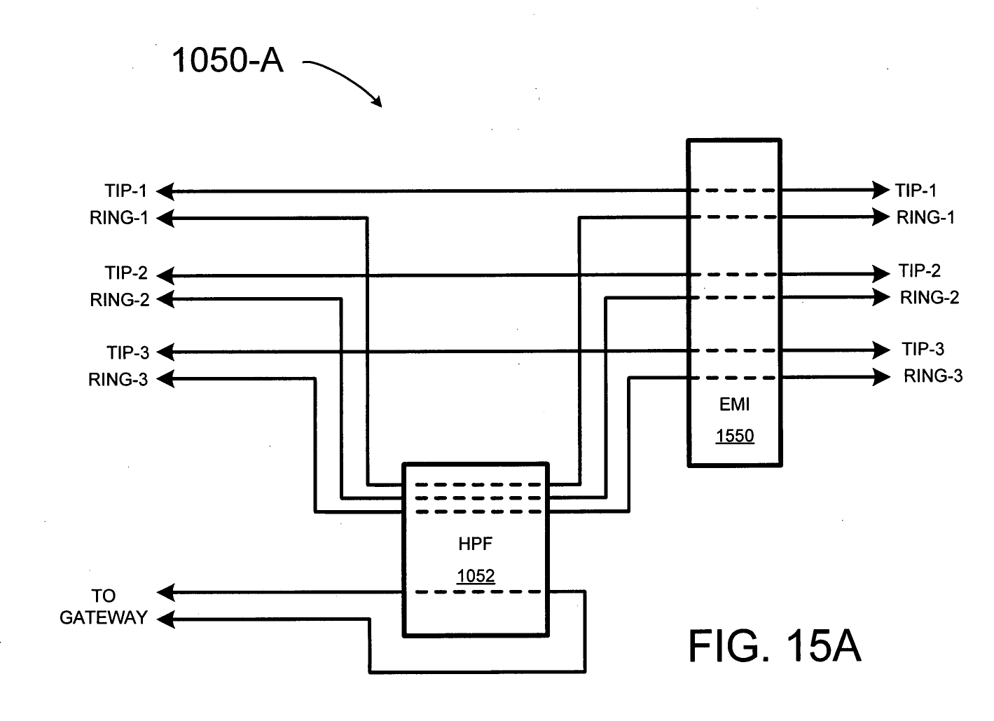

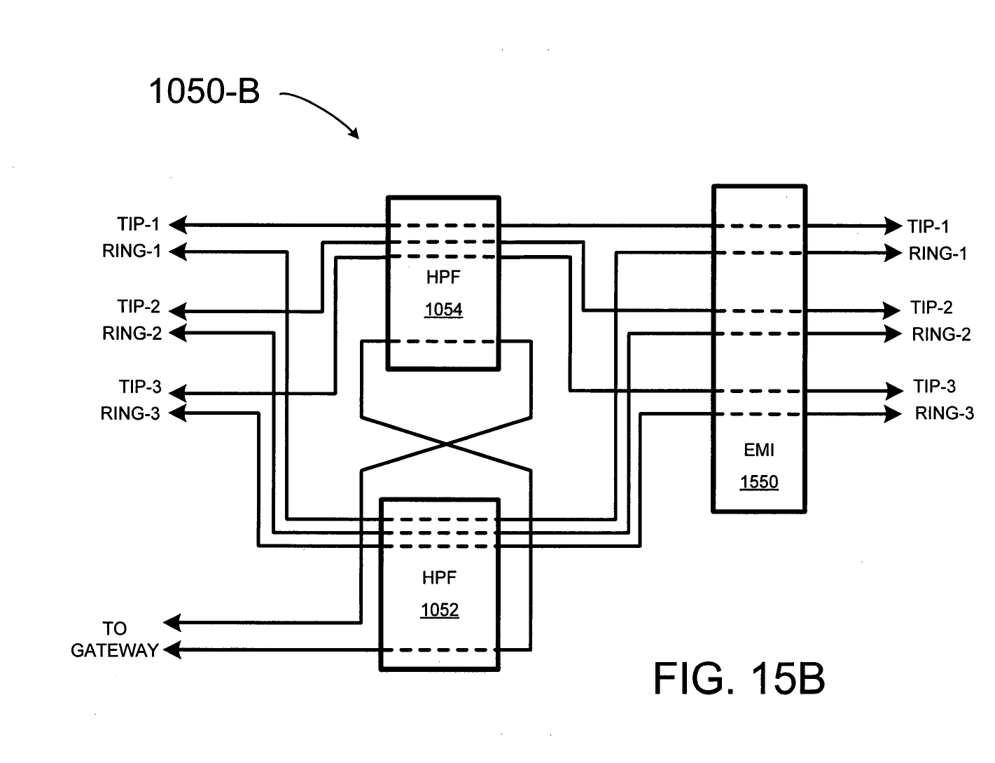

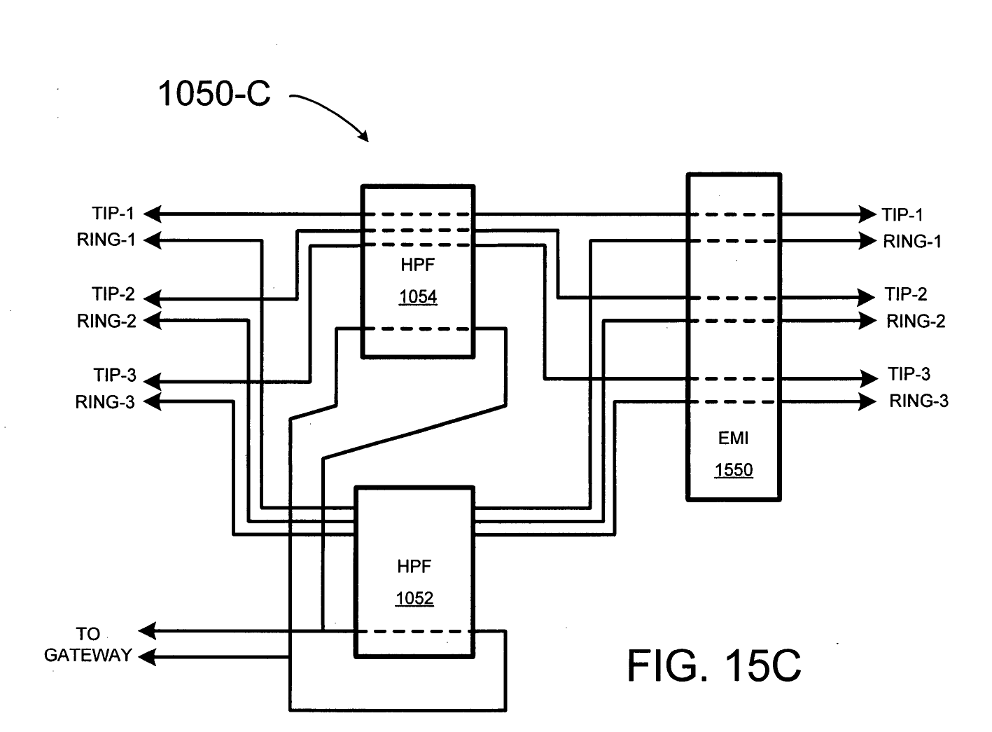

For example, FIG. 15A depicts a first embodiment where a first HPF/Coupler system 1050—As shown, a single coupling apparatus 1052 is used to inductively couples multiple RING lines and a gateway together. While the exemplary HPF/Coupler device 1052 is but a single ferrite bead having RING lines and a gateway input/output line run through it, in various other embodiments, the HPF/Coupler device 1052 can take a variety of other forms, such as a transformer, e.g., a ferrite or iron toroid, with each line having a single turn or multiple turns. In the present embodiment, the HPF/Coupler device 1052 is composed of a material as to couple signals having a frequency above 1-2 MHz and to isolate frequencies below 5-10 KHz for POTS-type lines, and below 100 KHz-500 KHz for ISDN lines. The HPF/Coupler device 1052 should also have sufficient mass to overcome any saturation that might be expected from current running through the TIP/RING lines.

In addition to the coupling apparatus 1052, an optional EMI filter 1550 can be added, which may be necessary in some embodiments to reduce system EMI to comply with various government regulations and/or to improve system performance.

Continuing to FIG. 15B, a second HPF/Coupler system 1050-B is depicted where coupling, as well as a certain amount of EMI filtering, can be accomplished via two separate coupling devices 1052 and 1054. As shown in FIG. 15B, coupling device 1052 is used to couple the gateway and the RING lines while coupling device 1054 is used to couple the gateway and the TIP lines. The gateway line has a series relationship with the two devices 1052 and 1054, with a turn between devices 1052 and 1054 so as to have an complementary inductive coupling effect. As with the coupling system 1050-A of FIG. 15A, devices 1052 and 1054 can be ferrite beads having the appropriate composition and mass described above, or can each take any of the other forms described above. Additionally, a similar EMI device 1550 can be optionally added to decrease EMI and/or improve system performance.

FIG. 15C depicts a third HPF/Coupler system 1050-C similar to that of FIG. 15B, but having a difference where the gateway line has a parallel (as opposed to series) relationship with devices 1052 and 1054, again with a turn between devices 1052 and 1054 so as to have an complementary inductive coupling effect.

While FIGS. 15A-15C depict a coupling architecture between a LAN-based gateway and a plurality of TIP/RING pairs, it should be appreciated that the same approach can be used to introduce WAN signals, or a combination of LAN and WAN signals, by passing a conductor through either or both of devices 1052 and 1054 in the same fashion as the gateway conductor is employed.

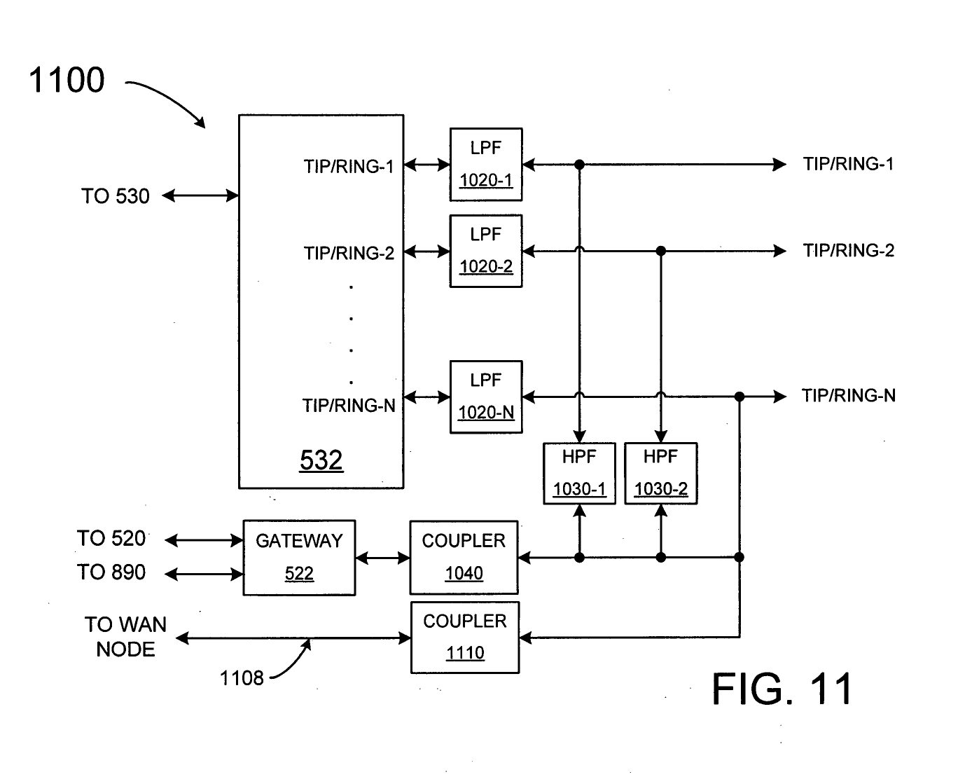

FIG. 11 depicts a coupling architecture 1100 for a LAN above WAN above Telephony network. The coupling architecture 1100 of FIG. 11 is nearly identical to that of FIG. 10D but includes a WAN coupler 1100 capable of coupling WAN signals to the gateway 522 and each client on the various TIP/RING wire-pairs. FIG. 11 again demonstrates the compatibility of established WAN above telephony technologies with the LAN-oriented methods and systems of the present disclosure.

The coupling architecture 1100 of FIG. 11 is nearly identical to that of FIG. 10D but includes a WAN coupler 1100 capable of coupling WAN signals to the gateway 522 and each client on the various TIP/RING wire-pairs. FIG. 11 again demonstrates the compatibility of established WAN above telephony technologies with the LAN-oriented methods and systems of the present disclosure.

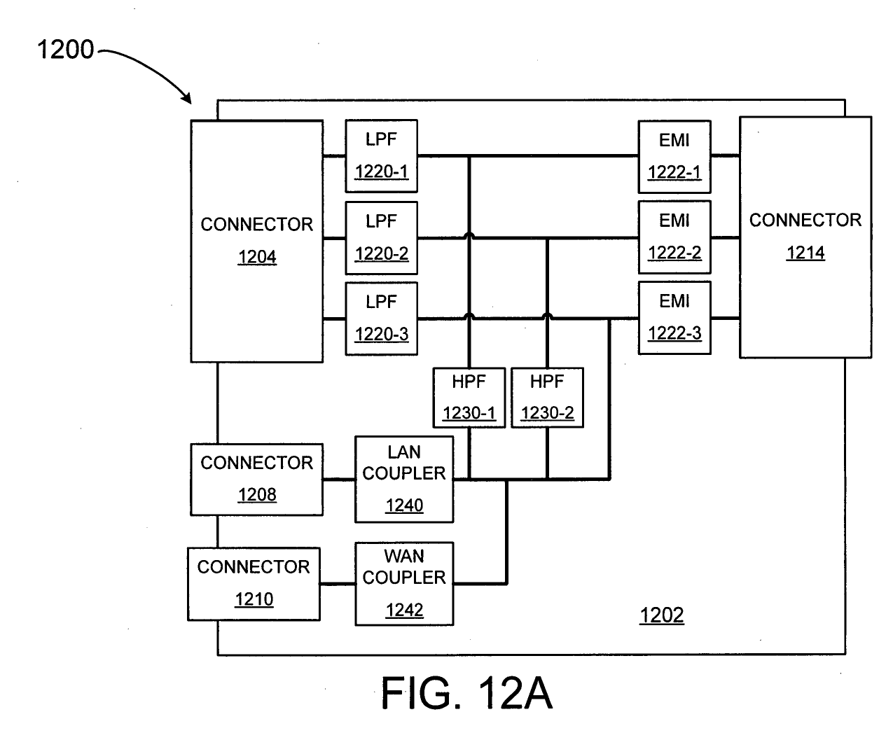

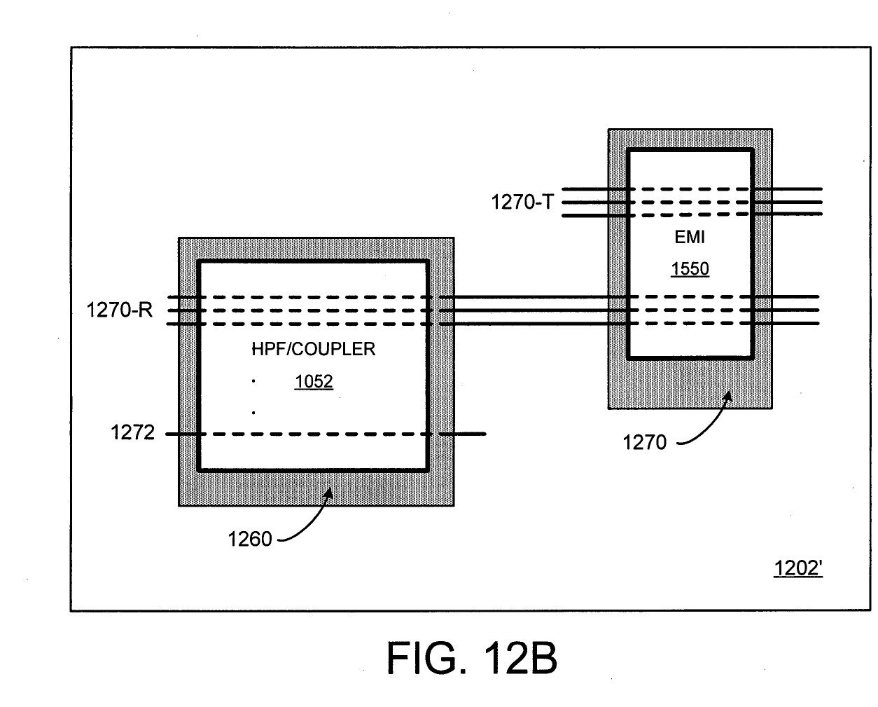

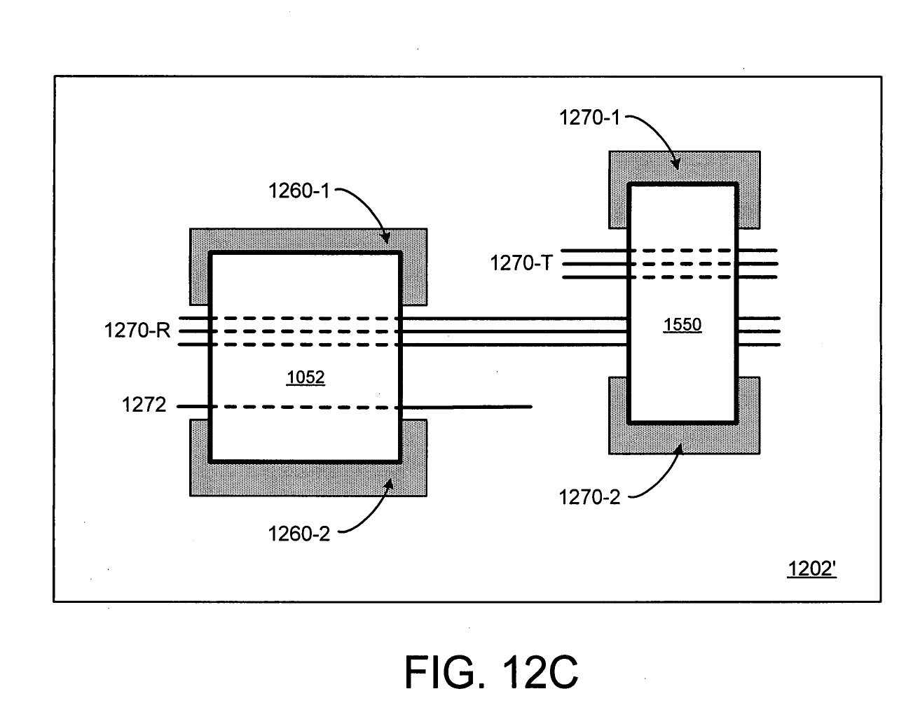

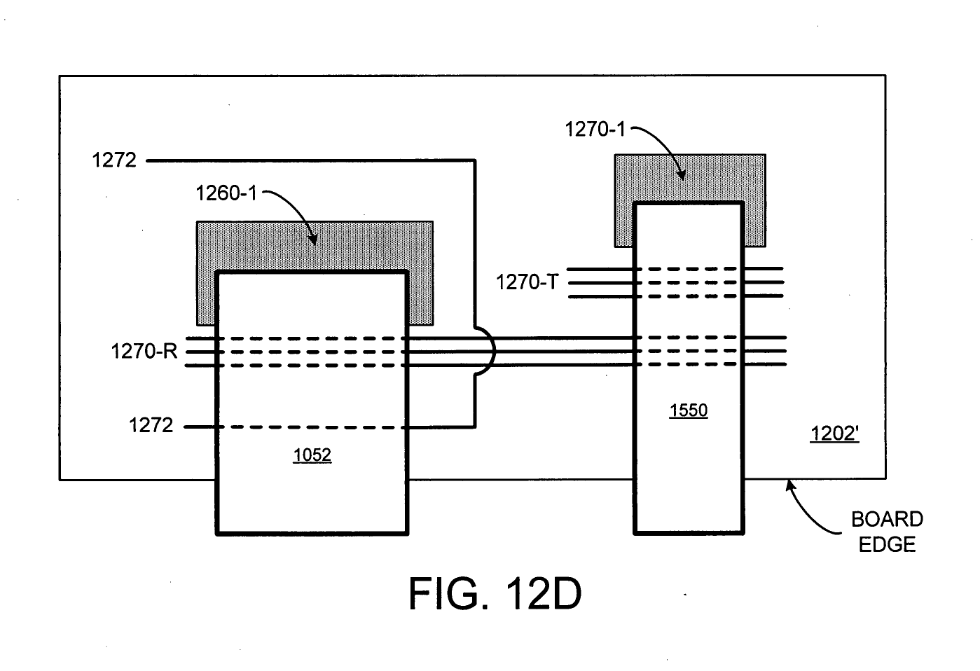

FIG. 12A depicts a LAN/WAN/T coupling device 1200 that consists of a circuit board 1202 (populated with various affixed devices) configured to support a LAN above WAN above Telephony network. As shown in FIG. 12, the basic architecture presented by coupling device 1200 is similar to architectures 1000D and 1100 discussed above (but limited to three TIP/RING line-pairs for clarity of presentation), and includes a series of optional LPFs 1220-1, 1220-2 and 1220-3, a series of HPFs 1230-1 and 1230-2, LAN coupler 1240 and WAN coupler 1242. However, it should be appreciated that the coupling device 1200 can take a variety of embodiments, including any of those depicted in FIGS. 10A-10E. For example, should the unified inductive coupler of FIG. 10E be used, the various high-pass filters and couplers may be replaced with a single device as will be discussed below. As with several of the devices described above, EMI circuits 1222-1 through 1222-3 can be optionally added for the reasons expressed above.

Returning to FIG. 12A, connectors 1204 and 1214 can be added to facilitate connection between various devices. The exemplary connectors 1204 and 1214 are standard 50-pin Centronics male and female couplers, but in a variety of embodiments, almost any suitable type and number of connectors may be used, such as an embodiment employing multiple RJ-11 connectors each providing a single TIP/RING pair connection.. Connectors 1208 and 1210 may also be Centronics or RJ-11 connectors, but may also be coaxial connectors or any other appropriate connector under the circumstances.

Depending on the particular LAN, WAN and telephony protocols used, it should be appreciated that the composition and specifications of the LPFs 1220-1, 1220-2 and 1220-3, HPFs 1230-1 and 1230-2, EMI devices 1222-1-1222-3 and filters residing in LAN coupler 1240 and WAN coupler 1242 can vary as required.

For example, the LPFs 1220-1, 1220-2 and 1220-3 can be configured to have a pass-band below 4 KHz for POTS and below 100 KHz for ISDN, and a frequency rejection band above frequencies of interest (see, FIG. 1 for example), e.g., >4 KHz, >100 KHz, >1 MHz, >2 MHz and >4 MHz to reject various LAN signals, or >25 KHz for certain WAN signals. However, the exact pass-band and rejection-band of each LPF 1220-1, 1220-2 or 1220-3 can be expected to vary from embodiment to embodiment taking into account the realities and tradeoffs of realized filters.

Similarly, each HPF 1230-1 or 1230-2 can be configured to have a pass-band >4 KHz, >25 KHz, >100 KHz, >1 MHz, >2 MHz and >4 MHz, as well as a rejection band of <4 KHz, <100 KHz, <1 MHz, <2 MHz and <4 MHz depending on the particular broadband and telephony broadband protocols used. As with the LPFs 1220-1, 1220-2 and 1220-3, the exact pass-band and rejection-band of each HPF 1230-1 or 1230-2 can be expected to vary from embodiment to embodiment taking into account the realities and tradeoffs of realized filters.

Further, each EMI device 1222-1 . . . 1222-3 may be required to withstand higher currents in certain embodiments or be able to absorb a different spectrum of EMI.

FIG. 12B depicts an embodiment of a section 1202′ of the board 1202 of FIG. 12A where the unified inductive coupling approach of 15A is employed. As shown in FIG. 12B, the circuit board portion 1202′ (the rest of board 1200 being omitted for clarity) has a first hole 1260 inset. A ferrite bead 1052 is placed in the hole 1260 and a number of RING (or TIP) wires 1270 and a gateway wire 1272 (with an optional WAN line possible) are stretched across the hole 1260-1 and through the HFP/coupler 1052 (in this embodiment a single ferrite device), in order to create a practical realization approach of the circuits of FIG. 15A-15C. In the present example, the various lines 1270 and 1272 are part of one or more ribbon cables soldiered to the circuit board at each end of the hole 1260. However, the particular makeup of the wiring and means of attachment can vary from embodiment to embodiment as may be found desirable or otherwise required.

As further shown in FIG. 12B, an EMI device 1550 (typically a ferrite similar to that of device 1052) can be deployed in hole 1270 in a similar fashion as with device 1052, with the difference being that both TIP lines 1270-T and RING lines 1270-R are passed through EMI device 1550 while no gateway signals are passed.

FIG. 12C depicts a variant embodiment of board section 1202′, but wherein two holes 1260-1 and 1260-2 are employed for the coupling device 1052 and two holes 1270-1 and 1270-2 are employed for the EMI device 1550. In this embodiment, either or both of devices 1052 and 1550 can take the form of a two-piece, clamp-like ferrite bead, with each piece of a respective bead making contact with one-another through the hole pairs 1260-1/1260-2 and 1270-1/1270-2 in order to form closed flux paths. Any or all of lines 1270-R, 1270-T and 1272 can be printed circuit board traces, as opposed to separate wiring.

FIG. 12D depicts a variant embodiment of board section 1202′ similar to that of FIG. 12C, but wherein only one of the holes 1260-1 and 1260-2 for coupling device 1052 are required, the second hole being obviated by deploying device 1052 near the edge of the board 1202. Similarly, only one of the holes 1270-1 and 1267-2 for EMI device 1550 are required, the second hole being obviated by similar deployment.

While FIGS. 12B-12D depict advantageous ways of combining inductive couplers and EMI devices and printed circuit boards, it should be appreciated that other embodiments may employ standard device-to-board mounting approaches or employ approaches whereby coupling and filtering devices are not affixed or even touching a circuit board.

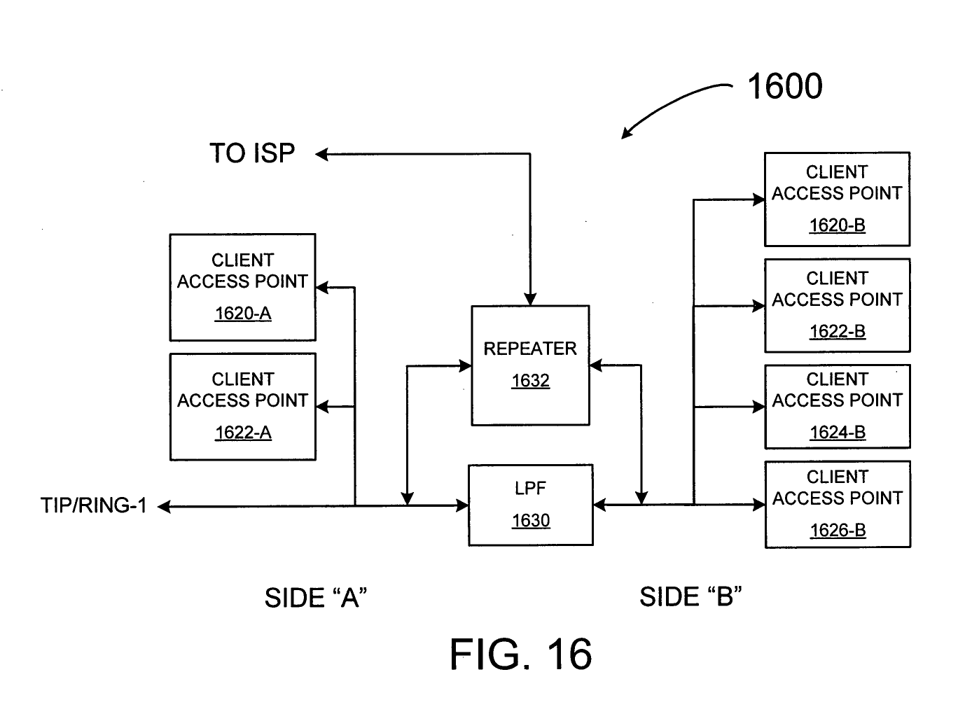

FIG. 16 depicts yet another coupling architecture 1600 for a LAN above WAN above Telephony network. Unlike the previous architectures discussed above where multiple phone lines are aggregated into a single LAN, coupling architecture 1600 uses a single TIP/RING pair to implement multiple LANs. As shown in FIG. 16, the coupling architecture 1600 has two sides: an “A” side and a “B” side that are isolated from one another via a low-pass filter 1630.

On the “A” side, client access points 1620-A and 1622-A can communicate freely with one another without interference from any of client access points 1640-B to 1646-B, while on the “B” side client access points 1640-B to 1646-B can freely communicate with one another without interference from client access points 1620-A and 1622-A. To facilitate any desired communications between the “A” network and the “B” network (or between the “A” network or the “B” network and an external device) repeater 1632 is provided as a bridge.

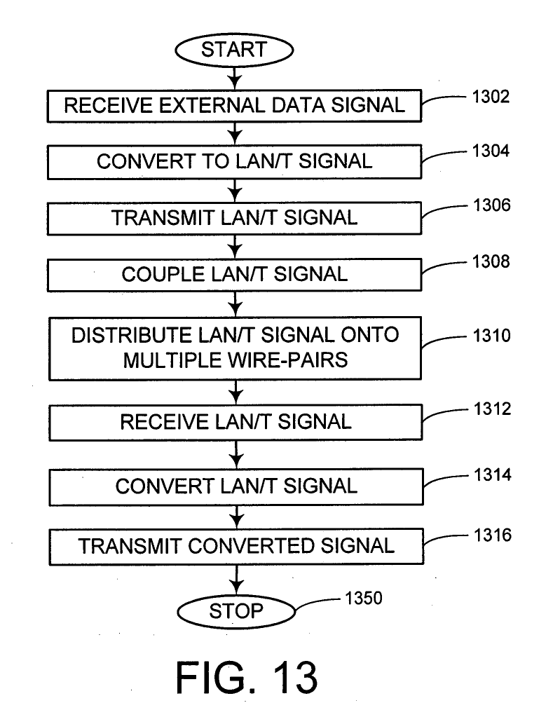

FIG. 13 is a flowchart outlining a first exemplary method for communicating using a LAN above Telephony network. The method starts in step 1302 where one or more data signals are received from an external device (such as an ISP or a particular computer-based device) by a gateway or bridge (or other suitable device). Next, in step 1304, the data signals are effectively converted to a high-frequency broadband LAN/T signal, such as the various LAN/T signals discussed above. Then, in step 1306, the LAN/T signals are transmitted over a wired telephone network, such as any of those telephony networks discussed above. As discussed above, the exemplary LAN/T signals can have any combination of the LAN traits (e.g., DES encryption and a CSMA/CA protocol) discussed above, but it should be appreciated that the particular combination of traits employed in a particular embodiment can vary as may be advantageous, required or otherwise desired from one embodiment to the next. Control continues to step 1308.

In step 1308, the transmitted LAN/T signals are then coupled onto at least a first wire-pair. As discussed above, LAN/T signals can be coupled onto each wire-pair of interest via separate coupling devices or via a single coupling device. Next, in step 1310 (which is optional and assumes a single coupler is used), the transmitted LAN/T signals are further distributed onto each wire-pair of interest via a series of HPFs. Then, in step 1312, the LAN/T signal is received by each intended recipient, e.g., a bridge of a client access point. Control continues to step 1314.

In step 1314, the received LAN/T signals are converted to an appropriate format, e.g., 10baseT or ethernet, so that they might be conveyed to a receiving device, e.g., a computer. Next, in step 1316, the converted signals are transmitted to a targeted receiving device. Control then continues to step 1350 where the process stops.

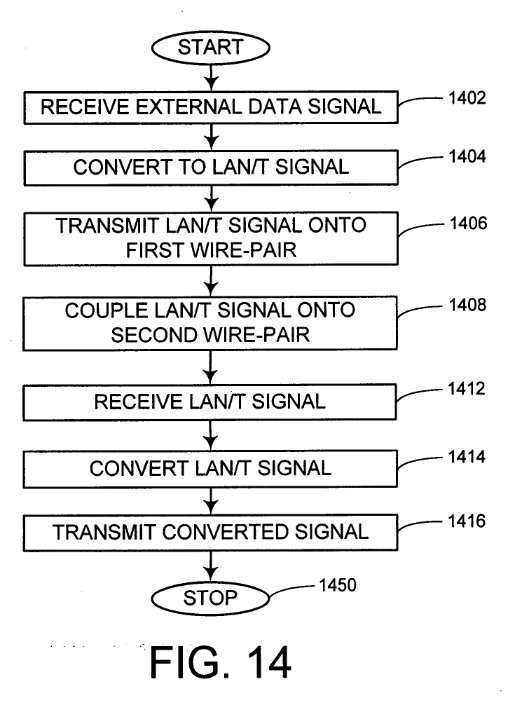

FIG. 14 is a flowchart outlining a second exemplary method for communicating using a LAN/Telephony network. The method starts in step 1402 where one or more data signals are received from an external device (such as a computer-based device) by a gateway or bridge (or other suitable device). Next, in step 1404, the data signals are effectively converted to a high-frequency broadband LAN/T signal, such as any of the various LAN/T signals discussed above. Then, in step 1406, the LAN/T signals are transmitted over a first wire-pair of the wired telephone network. Control continues to step 1408.

In step 1408, the transmitted LAN/T signals are then coupled from the first wire-pair onto a second wire-pair of the wired telephone network. As discussed above in reference to FIGS. 10A-11 such coupling can be made possible by a single HPF, multiple HPFs, one or more HPFs in tandem with a coupling device, and via one or more coupling devices. Also as discussed above, coupling may involve a gateway, bridge or other device acting as a repeater. Control continues to step 1412.

In step 1412, the LAN/T signal (repeated or original) is received by each intended recipient on the second wire-pair. Next, in step 1414, the received LAN/T signals are appropriately converted. Then, in step 1416, the converted signals are transmitted to a targeted receiving device. Control then continues to step 1450 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to communication services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A device for implementing a broadband communication network using a wired telephone network installed in a building, wherein the wired telephone network includes a telephony distribution device coupled to a plurality of telephone wire-pairs, and wherein each telephone wire-pair can carry a respective telephony signal, the device comprising:
a plurality of high-pass filters, wherein each high-pass filter is configured to electrically couple two telephone wire-pairs, and wherein each high-pass-filter is configured to pass high-frequency broadband communication signals while isolating low-frequency telephony signals.

2. The device of claim 1, further comprising a coupling device electrically coupled to at least a first wire-pair of the plurality of telephone wire-pairs, the coupling device being configured to receive high-frequency broadband signals from a computer-based device and injecting the high-frequency broadband signals onto the first wire-pair.

3. The device of claim 2, wherein the high-pass-filters are configured to couple the high-frequency broadband signals from the first wire-pair onto the remaining telephone wire-pairs.

4. The device of claim 3, further comprising a plurality of first low-pass-filters, wherein each first low-pass filter is imposed on a respective telephone wire-pair in such a way as to isolate the high-frequency broadband signals from a communication port of the telephony distribution device.

5. The device of claim 4, further comprising a plurality of second low-pass-filters, wherein each low-pass filter is coupled to one of the telephone wire-pair in such a way as to isolate the high-frequency broadband signals from a telephonic device accessing the telephony distribution device.

6. The device of claim 2, further a communication gateway coupled to the coupling device and being configured to transmit high-frequency broadband signals to the coupling device.

7. The device of claim 6, wherein the communication gateway is configured to transmit broadband local area network (LAN) based signals onto the telephone wire-pairs.

8. The device of claim 7, wherein power-levels of the transmitted broadband LAN-based signals are adjusted to eliminate or substantially minimize the effects of the broadband based signals on telephony equipment coupled to the telephone wire-pairs while maintaining communication with computer-based devices coupled to the telephone wire-pairs.

9. The device of claim 7, further comprising one or more client coupling devices coupled to one of the first wire-pairs, wherein each client coupling device is configured to receive telephony signals and broadband LAN-based signals and provide an output signal having one of the telephony signals and broadband LAN-based signals removed.

10. The device of claim 7, further comprising one or more client bridges coupled to one of the first wire-pairs, wherein each client bridge is configured to receive broadband LAN-based signals transmitted by either the communication gateway or another device coupled to one of the telephone wire-pairs.

11. The device of claim 7, wherein the broadband LAN-based signals transmitted by the communication gateway use an Orthogonal Frequency Division Multiplexed (OFDM) format.

12. The device of claim 7, wherein the broadband LAN-based signals transmitted by the communication gateway use a collision avoidance protocol.

13. The device of claim 12, wherein the broadband LAN-based signals transmitted by the communication gateway use a Carrier Sense Multiple Access/Collision Avoidance (CSMA/CA) protocol.

14. The device of claim 7, wherein the communication gateway is configured to communicate over the telephone wire-pairs using a substantially full spectral bi-directionality protocol.

15. The device of claim 7, wherein the broadband LAN-based signals transmitted by the communication gateway comply with the Homeplug 1.0 communication standard.

16. The device of claim 7, wherein the broadband LAN-based signals transmitted by the communication gateway comply with the Homeplug A/V communication standard.

17. The device of claim 7, wherein the communication gateway provides a communication interlink between an external Internet Service Provider (ISP) and at least one computer-based device coupled to the wired telephone network.

18. The device of claim 1, wherein the telephony signals on the wired network includes Plain Old Telephone Service (POTS)-based signals.

19. The device of claim 1, wherein the telephony signals on the wired network includes Integrated Services Digital Network (ISDN)-based signals.

20. The device of claim 1, wherein the telephone wire-pairs are part of a Private Branch eXchange (PBX) system or Private Automated Branch eXchange (PABX) system.

21. An apparatus for adapting a wired telephone network to carry a high-frequency broadband communication system, wherein the wired-network includes a plurality of twisted-wire-pairs with each twisted-wire-pair being capable of simultaneously carrying a separate telephonic communication signal, the device comprising:
a broadband communication device coupled to a first wire-pair, wherein the broadband communication device is configured to communicate over the first wire-pair using high-frequency broadband signals having a lowest frequency component greater than any frequency component of telephony signals traversing the first wired pair; and
at least one high-pass filter electrically connecting the first wire-pair to a second wired pair, wherein the high-pass filter is configured to allow high-frequency broadband signals to traverse between the first wire-pair and the second wire-pair while blocking telephony traffic from traversing between the first wire-pair and the second wire-pair.

22. A method for adapting a wired telephone network to work as a Local Area Network (LAN), wherein the wired-network includes a plurality of twisted-wire-pairs with each twisted-wire-pair being capable of simultaneously carrying a separate telephonic communication signal, the method comprising:
providing a high-pass filter between a first wire pair and a second wire pair, wherein the high-pass filter is configured to allow high-frequency broadband signals to traverse between the first wire-pair and the second wire-pair while blocking low- telephony traffic from traversing between the first wire-pair and the second wire-pair; and
broadcasting first high-frequency broadband signals onto the first wire-pair, wherein the high-frequency broadband signals are compliant with a LAN protocol.

23. A communication network for simultaneously transmitting telephonic and non-telephonic communication signals, comprising:
one or more couplers configured to receive non-telephonic communication signals from at least one gateway and inject the non-telephonic communication signals onto a wired telephone network, wherein the wired telephone network includes a telephonic external access device, a plurality of telephones and a plurality of respective telephone wire-pairs that are effectively isolated from one another at telephonic frequencies such that each wire-pair can carry a respective telephonic signal between the telephonic external access device and a respective telephone;
wherein the one or more couplers are configured to inject a common broadband signal onto all of the wire-pairs.

24. A Local Area Network (LAN), comprising:
a plurality of high-frequency communication devices, wherein each communication device is coupled to a respective wire-pair, and wherein each wire-pair is capable of carrying a separate low-frequency telephonic signal; and
a coupling means for coupling the high-frequency communication devices while isolating telephonic signals.

25. An apparatus for adapting a wired telephone network to carry a high-frequency broadband communication system, comprising:
a circuit board, the circuit board including:
a substrate;
a broadband coupler affixed to the substrate and adapted to couple high-frequency communication signals between a gateway and the circuit board; and
one or more high-pass-filters affixed to the substrate, each high-pass-filter having multiple ports and being configured to pass signals above 2 Mhz and reject signals below 10 KHz, wherein a first port of each high-pass-filter is electrically coupled to a first connector and wherein at least one high-pass-filter has a second port electrically coupled to a port of the broadband coupler; and
wherein each first connector is adapted to be connected to one of a plurality of twisted-wire-pairs of the wired telephone network, and wherein each twisted-wire-pair is capable of carrying a separate telephonic communication signal.

26. An apparatus for adapting a wired telephone network to carry a high-frequency broadband communication system, comprising:
a circuit board, the circuit board including:
a substrate;
a first inductive coupler associated with the circuit board, the first inductive coupler being configured to at least two TIP-RING pairs and configured to couple in a frequency region above 2 MHz while not substantially affecting telephony traffic on each of the TIP-RING pairs.

27. The apparatus of claim 26, wherein the first inductive coupler is configured to couple at least three TIP-RING pairs to a gateway.

28. The apparatus of claim 26, further comprising a second inductive coupler configured to work with the first inductive coupler and operate substantially in the same spectrum as the first inductive coupler, wherein the first inductive coupler couples TIP lines, the second inductive coupler couples RING lines.

29. The apparatus of claim 26, wherein the first inductive coupler is coupled to a single wire of each of the two or more TIP-RING pairs.

30. The apparatus of claim 28, wherein the first and second inductive couplers are configured to couple at least three TIP-RING pairs to a gateway.
